(19) United States
(12) Patent Application Publication
(10) Pub. No.: US 2020/0279024 A1
(43) Pub. Date: Sep. 3, 2020

(54) NON-TRANSITORY COMPUTER READABLE MEDIUM

(71) Applicant: FUJI XEROX CO., LTD., Tokyo (JP)

(72) Inventors: Shotaro MISAWA, Kanagawa (JP); Tomoki TANIGUCHI, Kanagawa (JP); Yasuhide MIURA, Kanagawa (JP); Tomoko OKUMA, Kanagawa (JP)

(73) Assignee: FUJI XEROX CO., LTD., TOKYO (JP)

(21) Appl. No.: 16/558,340

(22) Filed: Sep. 3, 2019

(30) Foreign Application Priority Data
Feb. 28, 2019 (JP) 2019-035783

(51) Int. Cl. G06F 17/28; G06N 3/08

(52) U.S. Cl. CPC G06F 17/2881; G06F 17/289; G06N 3/08; G06F 17/2836

(57) ABSTRACT

A non-transitory computer readable medium stores a program causing a computer to execute a process for learning. The process includes: generating, from an input text, an output text related to content of the input text and different from the input text by using a generation model that generates the output text from the input text; reconstructing the input text from the output text by using a reconstruction model that reconstructs the input text from the output text; and updating at least one of the generation model and the reconstruction model by causing the at least one of the generation model and the reconstruction model to perform learning by using a difference between the input text and a reconstructed text reconstructed in the reconstructing.

### CROSS-REFERENCE TO RELATED APPLICATIONS

This application is based on and claims priority under 35 USC 119 from Japanese Patent Application No. 2019-035783 filed Feb. 28, 2019.

### BACKGROUND

### (i) Technical Field

The present disclosure relates to a non-transitory computer readable medium.

### (ii) Related Art

Japanese Unexamined Patent Application Publication No. 2007-058829 discloses a device including a unit that inputs a sentence, a clause, or a word represented in a language (hereinafter referred to as A language), a unit that translates the input sentence, the input clause, or the input word into a sentence, a clause, or a word represented in a different language (hereinafter referred to as B language), a unit that translates the sentence, the clause, or the word represented in B language into a sentence, a clause, or a word represented in A language, and a unit that outputs the translated sentence, the translated clause, or the translated word. In the device, a sentence, a clause, or a word input in A language is automatically translated into one or more mutually different sentences, clauses, or words represented in B language, and one or more mutually different sentences, clauses, or words represented in B language are each automatically retranslated into a sentence, a clause, or a word represented in A language, and one of the translated sentences, the translated clauses, or the translated words represented in B language and the retranslated sentence, the retranslated clause, or the retranslated word represented in A language are paired and output one after another or simultaneously.

Japanese Unexamined Patent Application Publication No. 2016-218995 discloses a machine translation method performed in a machine translation system that is connected to an information output device and that executes a process for translation between a first language and a second language. The information output device outputs language information. In the machine translation method, a text in the first language to be translated is received. Multiple different forward-translated texts translated into the second language from the received text to be translated are generated. Multiple back-translated texts back translated into the first language from the respective different forward-translated texts are generated. If an operation for selecting a back-translated text from the back-translated texts is received when the back-translated texts are output in the information output device, a forward-translated text corresponding to the back-translated text is output.

Japanese Unexamined Patent Application Publication No. 2006-252323 discloses a data conversion aptitude evaluation method for calculating a conversion aptitude value. In the method, a data conversion device including a data conversion unit that converts first data to second data and an inverse data-conversion unit that performs inverse conversion of the second data to the first data is used. In the method, the conversion aptitude value is calculated by evaluating the conversion aptitude of the first data converted by the data conversion unit. The data conversion aptitude evaluation method includes data converting, data inverse-converting, similarity calculating, and conversion-aptitude-value outputting. In the data converting, converted second data is acquired by causing the data conversion unit to convert the first data. In the data inverse-converting, inversely converted first data is acquired by causing the inverse data-conversion unit to perform the inverse conversion of the converted second data. In the similarity calculating, the first data and the inversely converted first data are input to a similarity calculation unit, and the degree of similarity is calculated in accordance with a predetermined similarity formula. In the conversion-aptitude-value outputting, the degree of similarity is output from an output unit as a conversion aptitude value of the first data converted by the data conversion unit.

Japanese Unexamined Patent Application Publication (Translation of PCT Application) 2004-501429 discloses a machine translation decoding method including receiving a text segment in a source language to be translated into a target language, generating an initial translated text as a current target-language translation, applying one or more modification operators to the current target-language translation to generate one or more modified target language translations, verifying whether one or more of the modified target language translations each represent an improved translation in comparison with the current target-language translation, setting the modified target language translation as the current target-language translation, and repeating the applying, the verifying, and the setting until occurrence of a termination condition.

Japanese Unexamined Patent Application Publication No. 2006-318202 discloses a translation device including a translated-text generation unit, a display processing unit, a list generation unit, a candidate memory, an operation unit, and a retranslation processing unit. The translated-text generation unit generates a translated text that is translated into a second natural language from the input original text in a first natural language and also generates a back-translated text that is back-translated into the first natural language from the translated text. The display processing unit displays the translated text generated by the translated-text generation unit and the back-translated text in association with the original text. If a morpheme of the original text has multiple candidate translations into the second natural language, the list generation unit generates a list of the translations. The candidate memory stores the list. The operation unit receives an operation performed by a user. In response to an instruction from the user received by the operation unit, the retranslation processing unit selects one of the candidate translations from the list stored in the candidate memory. The retranslation processing unit causes the translated-text generation unit to regenerate a translated text and a back-translated text by using the selected translation as a translation of the corresponding morpheme.

Japanese Patent No. 5100445 discloses a machine translation device including an example memory, an input receiving unit, a search unit, a translation unit, a detection unit, and an output unit. The example memory stores therein a target language example and a source language example having meaning equivalent to that of the target language example in connection with each other. The input receiving unit receives an input text in the source language. The search unit searches the example memory for a target language example that matches or is similar to the input text connected with a source language example. The translation unit generates a target language text translated into the target language from the input text and also generates a re-translated text translated into the source language from the found target language example. The detection unit detects a difference between the re-translated text and the input text. The output unit outputs the difference.

### SUMMARY

Aspects of non-limiting embodiments of the present disclosure relate to a non-transitory computer readable medium enabled to restrain, from having a generalized representation, an output text related to the content of an input text and different from the input text.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a non-transitory computer readable medium storing a program causing a computer to execute a process for learning, the process including: generating, from an input text, an output text related to content of the input text and different from the input text by using a generation model that generates the output text from the input text; reconstructing the input text from the output text by using a reconstruction model that reconstructs the input text from the output text; and updating at least one of the generation model and the reconstruction model by causing the at least one of the generation model and the reconstruction model to perform learning by using a difference between the input text and a reconstructed text reconstructed in the reconstructing.

### BRIEF DESCRIPTION OF THE DRAWINGS

An exemplary embodiment of the present disclosure will be described in detail based on the following figures, wherein:

FIG. 1 is a schematic configuration diagram illustrating the configuration of an information processing apparatus;

FIG. 2 is a functional block diagram at the time when the information processing apparatus functions as a learning device;

FIG. 3 is a flowchart of a learning process;

FIG. 4 is a functional block diagram at the time when the information processing apparatus functions as a text generation device;

FIG. 5 is a flowchart of a text generation process;

FIG. 6 is a view illustrating an example of a receiving screen;

FIG. 7 is a view illustrating an example screen having a catch phrase displayed thereon;

FIG. 8 is a view illustrating an example screen displayed after the catch phrase is modified;

FIG. 9 is a view illustrating an example screen having multiple catch phrases displayed thereon;

FIG. 10 is a view illustrating an example screen for setting notable words;

FIG. 11 is a view illustrating an example screen for receiving the catch phrase as an input text; and

FIG. 12 is a view illustrating an example screen on which words generated from the catch phrase are displayed.

### DETAILED DESCRIPTION

Hereinafter, an exemplary embodiment of the present disclosure will be described in detail with reference to the drawings.

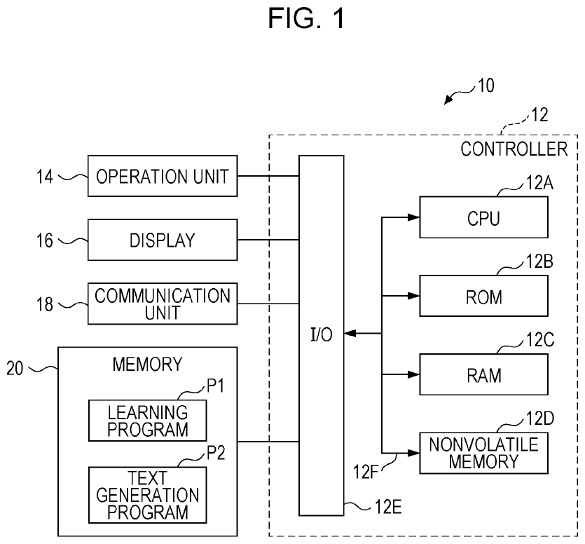

FIG. 1 is a diagram of the configuration of an information processing apparatus 10. The information processing apparatus 10 has functions (described later) of a learning device and a text generation device.

As illustrated in FIG. 1, the information processing apparatus 10 is an apparatus including a general computer and is composed of, for example, a personal computer.

As illustrated in FIG. 1, the information processing apparatus 10 includes a controller 12. The controller 12 includes a central processing unit (CPU) 12A, a read only memory (ROM) 12B, a random access memory (RAM) 12C, a nonvolatile memory 12D, and an input/output (I/O) interface 12E. The CPU 12A, the ROM 12B, the RAM 12C, the nonvolatile memory 12D, and the I/O 12E are connected to each other via a bus 12F.

In addition, an operation unit 14, a display 16, a communication unit 18, and a memory 20 are connected to the I/O 12E.

The operation unit 14 includes, for example, a mouse and a keyboard.

The display 16 is composed of, for example, a liquid crystal display.

The communication unit 18 is an interface for performing data communications with an external device.

The memory 20 is composed of a nonvolatile memory such as a hard disk and stores therein a learning program P1, a text generation program P2, and the like (described later). When the CPU 12A reads out and runs the learning program P1 stored in the memory 20, the information processing apparatus 10 functions as a learning device. When the CPU 12A reads out and runs the text generation program P2 stored in the memory 20, the information processing apparatus 10 functions as a text generation device.

The functional configuration of the CPU 12A at the time when the information processing apparatus 10 functions as the learning device will be described.

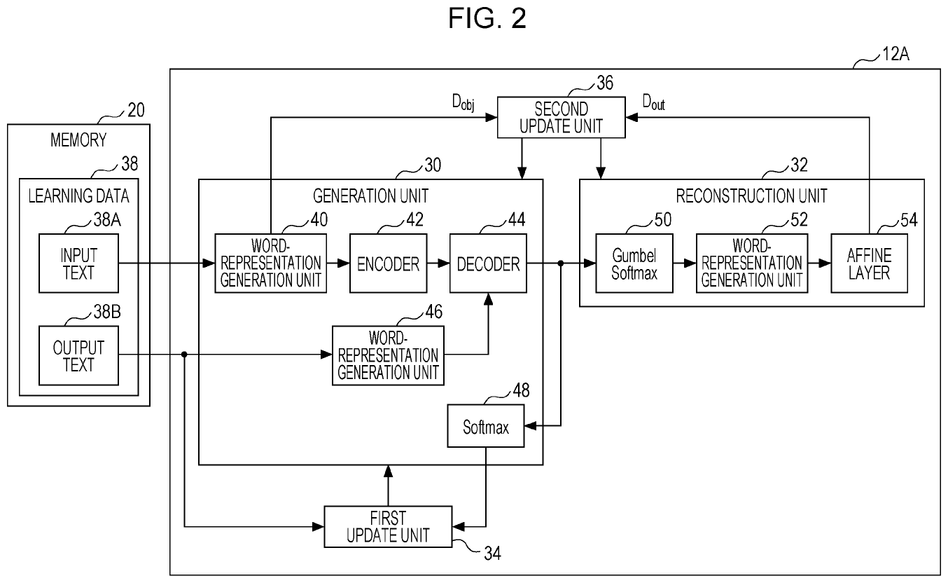

As illustrated in FIG. 2, the CPU 12A functionally includes a generation unit 30, a reconstruction unit 32, a first update unit 34, and a second update unit 36. The first update unit 34 and the second update unit 36 are each an example of an update unit.

The generation unit 30 generates an output text from an input text by using a generation model that generates an output text related to the content of an input text and different from the input text.

A case where the generation model generates an output text shorter than an input text will be described in this exemplary embodiment. Examples of the output text shorter than the input text include a catch phrase clearly representing the input text, a summation summarizing the input text, and the headline of the input text but are not limited to these examples. A case where the generation unit 30 generates a catch phrase as the output text will be described in this exemplary embodiment.

The generation unit 30 acquires the input text from learning data 38 stored in the memory 20. The learning data 38 includes a large number of pairs of input texts 38A and correct output texts (catch phrases) 38B.

The generation model used by the generation unit 30 is, for example, an encoder-decoder model with an attention mechanism in this exemplary embodiment. The attention mechanism generates an output text in such a manner as to perform weighting on words included in an input text. The encoder-decoder model used in this exemplary embodiment is also a learning model based on, for example, recurrent neural network (RNN).

Specifically, the generation unit 30 includes a word-representation generation unit 40, an encoder 42, a decoder 44, a word-representation generation unit 46, and a Softmax layer 48.

The word-representation generation unit 40 functions as a so-called embedding layer. The word-representation generation unit 40 acquires words x₁, x₂, . . . xₙ (n corresponds to the number of words) constituting an input text 38A included in the learning data 38 from the memory 20 and generates a word representation of each of the acquired words constituting the input text 38A. The word-representation generation unit 40 then outputs the generated word representation of each word to the encoder 42.

The word-representation generation unit 40 calculates a mean value of the word representations of the generated words (average pooling) and outputs the calculated value as D_{obj} to the second update unit 36. The word-representation generation unit 40 may calculate a total value of the word representations of the words, instead of the mean value.

The encoder 42 encodes the word representation of each word generated by the word-representation generation unit 40 and outputs the word representation to the decoder 44.

The decoder 44 generates the word representation of a catch phrase word by word on the basis of the information output from the encoder 42. The decoder 44 serving as the attention mechanism performs weighting on the word representation of the word output from the encoder 42 and generates the word representations of the catch phrase.

As described above, the generation unit 30 generates the word representation of the input text and outputs the output text in the word representation.

The word-representation generation unit 46 functions as an embedding layer and acquires, from the memory 20, words y₁, y₂, . . . yₙ (n corresponds to the number of words) constituting a correct output text 38B included in the learning data 38. The word-representation generation unit 46 generates the word representation of each of the acquired words y₁, y₂, . . . yₙ constituting the output text 38B and outputs the word representation to the decoder 44.

The Softmax layer 48 converts the word representations of the catch phrase output from the decoder 44 to words x′₁, x′₂, . . . x′ₙ (n corresponds to the number of words) and outputs the words x′₁, x′₂, . . . x′ₙ to the first update unit 34. The Softmax layer 48 also calculates probability representing the correctness of the catch phrase output from the decoder 44 by using a so-called Softmax function.

The encoder 42, the decoder 44, and the attention mechanism are caused to perform learning, for example, simultaneously and acquire a catch phrase with a high a-posteriori probability by using the beam search method when the catch phrase is generated. In addition, the encoder 42 and the decoder 44 include, for example, a bidirectional gated recurrent unit (GRU) as an internal structure.

The reconstruction unit 32 reconstructs an input text from an output text by using a reconstruction model that reconstructs the input text from the output text generated by the generation unit 30.

Specifically, the reconstruction unit 32 includes a GumbelSoftmax layer 50, a word-representation generation unit 52, and an affine layer 54.

The GumbelSoftmax layer 50 converts the word representations of the respective words in the catch phrase output from the decoder 44 of the generation unit 30 to words y′₁, y′₂, . . . y′ₙ (n corresponds to the number of words) constituting the reconstructed text by using a so-called GumbelSoftmax function and outputs the words y′₁, y′₂, . . . y′ₙ to the word-representation generation unit 52.

The word-representation generation unit 52 generates the word representations of the words y′₁, y′₂, . . . y′ₙ of the catch phrase output from the GumbelSoftmax layer 50. The word-representation generation unit 52 calculates the mean value of the generated word representations (average pooling) and outputs the mean value to the affine layer 54. The word-representation generation unit 52 may calculate the total value of the word representations of the words, instead of the mean value. As described above, the reconstruction model in the reconstruction unit 32 acquires the words generated from the output text represented in the word representations by using the Gumbel-Softmax function and generates the reconstructed text represented in the word representations on the basis of the distributed representation of the acquired words. In this exemplary embodiment, the word-representation generation unit 52 uses a learning model based on, for example, a convolutional neural network (CNN).

The affine layer 54 performs linear transformation of the mean value of the word representations of the catch phrase output from the word-representation generation unit 52 and outputs the value resulting from the linear transformation as Dₒᵤₜ to the second update unit 36. As described above, the reconstruction unit 32 generates the reconstructed text from the output text represented in the word representations.

The reconstruction unit 32 may reconstruct the input text from at least one word having a degree of importance equal to or higher than a predetermined degree of importance among the words included in the output text output from the generation unit 30. Specifically, among the word representations of the respective words in the catch phrase output from the decoder 44 of the generation unit 30, the word representation of only the at least one word having a degree of importance equal to or higher than the predetermined degree of importance may be input to the GumbelSoftmax layer 50. In addition, the reconstruction unit 32 may reconstruct the input text from at least one word having a degree of importance equal to or higher than a predetermined degree of importance among the words included in the reconstructed text. The degree of importance of a word may be learned by using the learning model with the attention mechanism.

The degree of importance of each word included in the output text may be calculated by using term frequency-inverse document frequency (tf-idf). Specifically, a tf-idf value is calculated for each word in each input text included in the learning data 38 and is set as the degree of importance.

Note that tf is a parameter representing the number of times a word appears. For example, a tf value of a word X included in an input text A is calculated by dividing the number of times the word X included in the input text A appears by the sum of the numbers of times all of the words included in the input text A appear.

In contrast, idf stands for inverse document frequency. The smaller the number of times a word in a document appears in a different input text, the higher the value. The larger the number of times a word in a document appears in a different input text, the lower the value.

In addition, tf-idf takes on a value obtained by multiplying the tf value by the idf value. Accordingly, a word that appears frequently in an input text but does not appear in a different input text has a high tf-idf value, and the other words have a lower tf-idf value.

The first update unit 34 causes the generation model to perform learning by using a difference L1 between the correct output text 38B paired with the input text 38A and the output text output from the generation unit 30 and thereby updates the generation model. The first update unit 34 may be omitted.

The second update unit 36 causes the generation model used by the generation unit 30 and the reconstruction model used by the reconstruction unit 32 to perform learning by using a difference L2 between the input text and the reconstructed text reconstructed by the reconstruction unit 32 and thereby updates the generation model and the reconstruction model. Specifically, the difference L2 is a difference between the value D_{obj} calculated by the word-representation generation unit 40 of the generation unit 30 and the value Dₒᵤₜ output from the affine layer 54 of the reconstruction unit 32.

The second update unit 36 may be configured as follows. Specifically, the second update unit 36 receives an input text input to the generation unit 30, a reconstructed text reconstructed by the reconstruction unit 32, and at least one input text different from the input text input to the generation unit 30. By using a model for calculating probability at which one of the input texts and the reconstructed text are paired and probability at which the other input text and the reconstructed text are paired, the second update unit 36 calculates a difference in probability at which the input text input to the generation unit 30 and the reconstructed text reconstructed by the reconstruction unit 32 are paired. The generation model and the reconstruction model are caused to perform learning by using the calculated difference and thereby are updated.

In this exemplary embodiment, the case where the second update unit 36 performs learning and update of the generation model and the reconstruction model but may perform the learning and the update on one of the generation model and the reconstruction model.

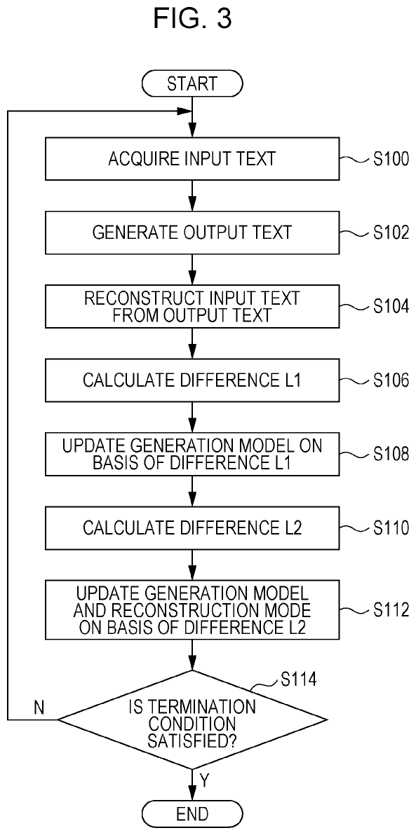

A learning process executed by the CPU 12A when the information processing apparatus 10 functions as the learning device will be described with reference to a flowchart illustrated in FIG. 3. The learning process illustrated in FIG. 3 is executed when the execution of the learning process is instructed in accordance with a user operation. When the execution of the learning process is instructed, the CPU 12A reads and runs the learning program P1 stored in the memory 20.

In step S100, in the CPU 12A, the generation unit 30 refers to the learning data 38 stored in the memory 20 and acquires an input text 38A.

In step S102, in the CPU 12A, the generation unit 30 generates a catch phrase as an output text from the input text 38A acquired in step S100.

In step S104, in the CPU 12A, the reconstruction unit 32 reconstructs the input text from the catch phrase generated in step S102 and thereby generates a reconstructed text.

In step S106, in the CPU 12A, the first update unit 34 calculates the difference L1 between the correct output text 38B paired with the input text 38A and the output text generated in step 102.

In step S108, in the CPU 12A, the first update unit 34 causes a parameter for the generation model to be learned by using the difference L1 calculated in step S106 and thereby updates the generation model. Alternatively, steps S106 and S108 may be performed before step S104.

In step S110, in the CPU 12A, the second update unit 36 calculates the difference L2 between the word representation of the input text 38A acquired in step S100 and the corresponding word representation of the reconstructed text reconstructed in step S104.

In step S112, in the CPU 12A, the second update unit 36 causes parameters for the generation model and the reconstruction model to be respectively learned by using the difference L2 calculated in step S110 and thereby updates the generation model and the reconstruction model.

In step S114, it is determined whether a termination condition for terminating the learning is satisfied. The termination condition may be, for example, the execution of the generation of catch phrases for a predetermined number of input texts 38A or the execution of the generation of catch phrases for all of the input texts 38A.

If the termination condition is satisfied, this routine is terminated. In contrast, if the termination condition is not satisfied, the routine returns to step S100 and acquires an unprocessed input text and repeats the same steps as described above.

In this exemplary embodiment as described above, the input text is reconstructed from the catch phrase by using the reconstruction model that reconstructs the input text from the catch phrase, and the generation model and the reconstruction model are caused to perform learning by using the difference between the input text and the reconstructed text. Accordingly, the catch phrase is restrained from having a generalized representation, and a catch phrase representing content unique to the input text is thereby generated.

For example, if the input text is “Will be involved in new service development in AI and ICT fields. Looking for a person experienced in coding using Python.”, a catch phrase in a generalized representation is likely to be generated in the related art, such as “Looking for an engineer!” or “IT engineer urgently wanted!”. In contrast, with the generation model caused to perform learning when the information processing apparatus 10 according to this exemplary embodiment functions as the learning device, catch phrases representing the content unique to the input text are generated instead of the generalized representation, such as “We need your skills! Looking for an engineer able to write Python!” or “Best for training to set up business on your own! An engineer involved in a new service in the AI field!”.

Note that in steps S108 and S112, the learning may be performed on the generation model and the reconstruction model on the basis of a difference L calculated in accordance with the following formula.

L=L1+λ×L2

Note that λ is a parameter for controlling the degree of the learning using the difference L1 and the difference L2. The parameter λ may take on a predetermined value or may be configured to allow a user to set any value.

The functional configuration of the CPU 12A at the time when the information processing apparatus 10 functions as the text generation device will be described.

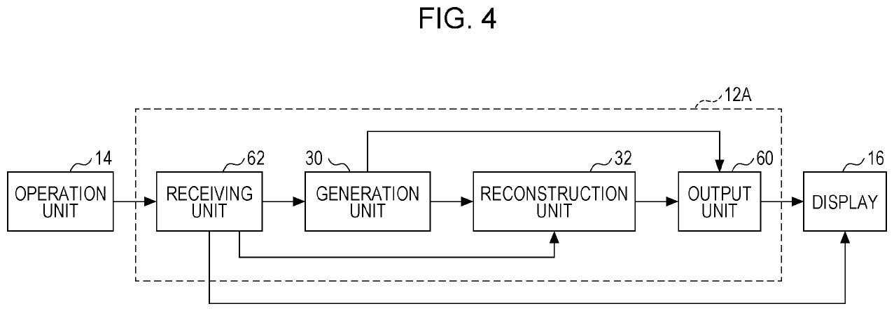

As illustrated in FIG. 4, the CPU 12A functionally includes the generation unit 30, the reconstruction unit 32, an output unit 60, and a receiving unit 62. The receiving unit 62 is an example of a threshold receiving unit, a modification receiving unit, and a notable-word receiving unit.

The generation unit 30 generates an output text from an input text by using the generation model caused to perform learning when the information processing apparatus 10 functions as the learning device, as described above. The output text is output from the Softmax layer 48 in FIG. 2.

The reconstruction unit 32 reconstructs the input text from the output text by using the reconstruction model caused to perform learning when the information processing apparatus 10 functions as the learning device, as described above.

The output unit 60 outputs at least one of the output text generated by the generation unit 30 and the reconstructed text reconstructed by the reconstruction unit 32. A case where at least one of the output text generated by the generation unit 30 and the reconstructed text reconstructed by the reconstruction unit 32 is output to the display 16 is described in this exemplary embodiment; however, the at least one of the output text and the reconstructed text may be output to an external device via the communication unit 18 or may be output and stored to and in the memory 20.

The receiving unit 62 functions as the threshold receiving unit. In the case where the receiving unit 62 functions as the threshold receiving unit, the receiving unit 62 receives a threshold used in a case where the reconstruction unit 32 outputs only at least one reconstructed text of the reconstructed texts that has a difference lying between the input text and the reconstructed text and having a value lower than or equal to the threshold. The difference is the difference L2 described above and is calculated by, for example, the reconstruction unit 32.

The receiving unit 62 also functions as the modification receiving unit. In the case where the receiving unit 62 functions as the modification receiving unit, the receiving unit 62 receives the modification of the output text generated by the generation unit 30.

The receiving unit 62 also functions as the notable-word receiving unit. In the case where the receiving unit 62 functions as the notable-word receiving unit, the receiving unit 62 receives at least one notable word to be noticed among words included in the input text. In this case, the generation unit 30 outputs at least one of generated output texts that includes the notable word received by the receiving unit 62.

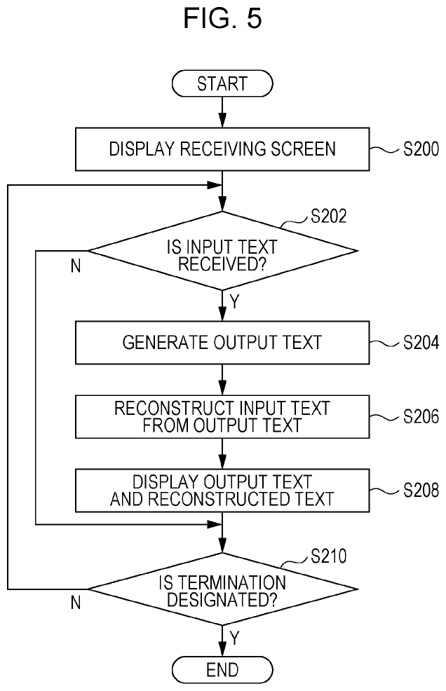

A text generation process executed by the CPU 12A when the information processing apparatus 10 functions as the text generation device will be described with reference to a flowchart illustrated in FIG. 5. The text generation process illustrated in FIG. 5 is executed when the execution of the text generation process is instructed in accordance with a user operation. When the execution of the text generation process is instructed, the CPU 12A reads and runs the text generation program P2 stored in the memory 20.

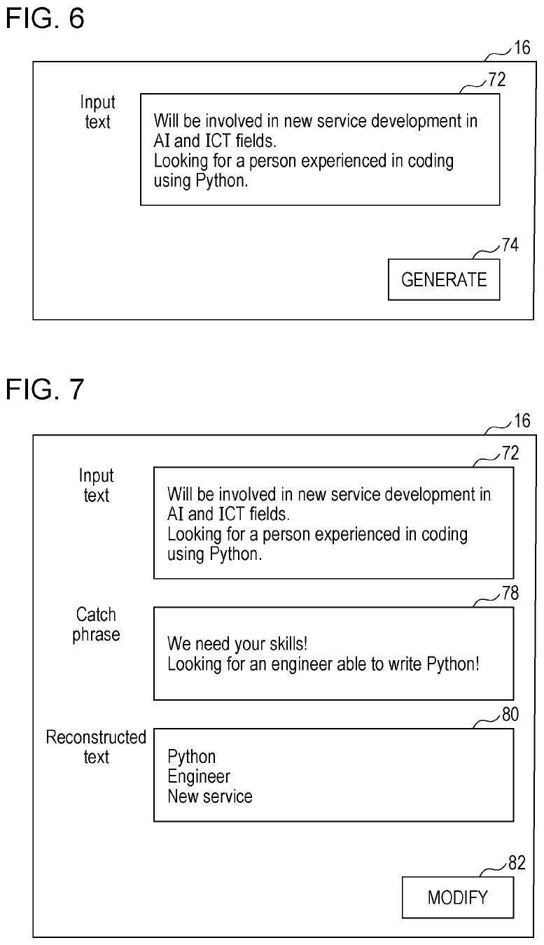

In step S200, in the CPU 12A, the receiving unit 62 displays a receiving screen as illustrated in FIG. 6 on the display 16. The receiving screen illustrated in FIG. 6 includes an input field 72 for inputting an input text and a generation button 74 for giving an instruction to generate a catch phrase. The user gives an instruction to generate a catch phrase by inputting an input text as the source of the catch phrase into the input field 72 and pressing the generation button 74.

In step S202, in the CPU 12A, the receiving unit 62 determines whether the input text is received, that is, whether the generation button 74 is pressed. If the generation button 74 is pressed, the process moves to step S204. If the generation button 74 is not pressed, the process moves to step S210.

In step S204, in the CPU 12A, the generation unit 30 generates a catch phrase as an output text from the input text input into the input field 72.

In step S206, in the CPU 12A, the reconstruction unit 32 reconstructs the input text from the catch phrase generated in step S204.

In step S208, in the CPU 12A, the output unit 60 displays, on the display 16, the catch phrase generated in step S204 and the reconstructed text in which the input text is reconstructed from the catch phrase in step S206. The case where both of the catch phrase and the reconstructed text are displayed on the display 16 is described in this exemplary embodiment; however, only the catch phrase or only the reconstructed text may be displayed on the display 16.

FIG. 7 illustrates an example screen displayed when the catch phrase generated in step S204 and the reconstructed text reconstructed in step S206 are displayed on the display 16. In the example in FIG. 7, the following case is illustrated. The input text “Will be involved in new service development in AI and ICT fields. Looking for a person experienced in coding using Python.” is input into the input field 72. The catch phrase “We need your skills! Looking for an engineer able to write Python!” is displayed in an output field 78, and the reconstructed texts “Python”, “Engineer”, and “New service” are displayed in a reconstruction field 80.

There is a case where the user intends to modify a generated catch phrase. In this case, as illustrated in FIG. 7, the modification of the catch phrase displayed in the output field 78 may be received in response to the pressing of a modification button 82. In this case, after the user completes the modification of the catch phrase displayed in the output field 78, a reconstructed text in which the input text is reconstructed from the catch phrase updated with the modification may be displayed in the reconstruction field 80.

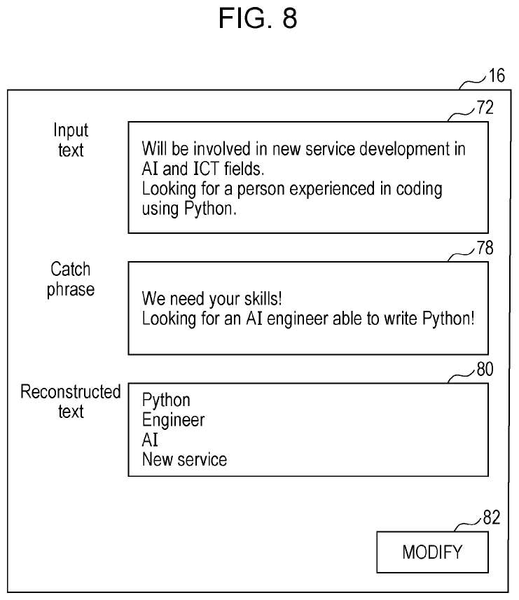

FIG. 8 illustrates an example of catch phrase modification. FIG. 8 illustrates the example where modification is performed by adding the characters “AI” before “engineer” in the catch phrase displayed in the output field 78 and where as the result of re-reconstruction of the modified catch phrase, “AI” is added in the reconstruction field 80. As described above, after the catch phrase is modified, how the reconstructed text is changed in response to the modification may be known.

Note that multiple catch phrases may be generated, and the multiple catch phrases and reconstructed texts connected with the respective multiple catch phrases may be displayed on the display 16.

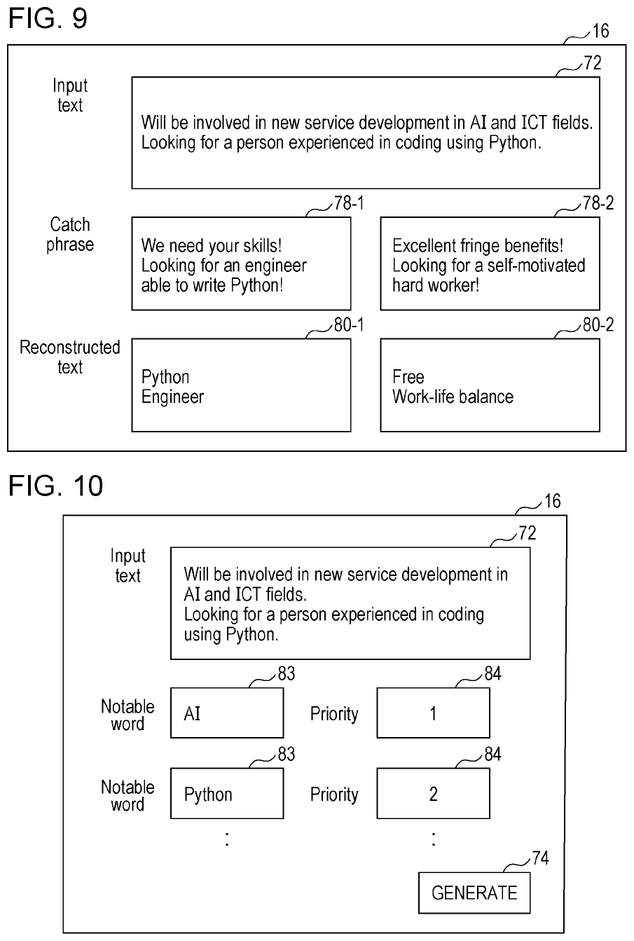

FIG. 9 illustrates an example where two catch phrases and reconstructed texts connected with the respective catch phrases are displayed on the display 16. In the example in FIG. 9, the first catch phrase “We need your skills! Looking for an engineer able to write Python!” generated in response to the input text input into the input field 72 is displayed in an output field 78-1. In addition, “Python” and “Engineer” are displayed as reconstructed texts connected with the first catch phrase in a reconstruction field 80-1. The second catch phrase “Excellent fringe benefits! Looking for a self-motivated hard worker!” generated in response to the input text input into the input field 72 is displayed in an output field 78-2. In addition, “Free” and “Work-life balance” are displayed as reconstructed texts connected with the second catch phrase in a reconstruction field 80-2. This helps the user to select an optimum catch phrase from the multiple catch phrases.

Only at least one reconstructed text having the difference L2 lying between an input text and a reconstructed text and having a value lower than or equal to the threshold may be displayed on the display 16. In this case, the receiving unit 62 may be configured to receive the threshold set by the user. For example, the smaller the threshold, the more limited the content of the catch phrase. Enabling the user to set the threshold enables the user to control the degree of reconstruction.

An output text having combination of words at least partially different from the combination of words included in the reconstructed text may be selected from among the multiple generated output texts and may be displayed on the display 16.

For example, in response to the input text input into the input field 72 in FIG. 6, “Come on and join us to build up the future world with AI!”, “A new service to be launched! Commit and commit yourself!”, and “We need your skills! Looking for an engineer able to write Python!” are respectively generated as a first catch phrase, a second catch phrase, and a third catch phrase. Reconstructed texts reconstructed from the first catch phrase are “AI”, “World”, and “Innovation”, reconstructed texts reconstructed from the second catch phrase are “Engineer” and “New service”, and reconstructed text reconstructed from the third catch phrase are “Python”, “Engineer”, and “New service”. In this case, the first catch phrase and the third catch phrase have combination having the smallest difference in overlapping with the words in the corresponding reconstructed text. Accordingly, instead of displaying all of the first to third catch phrases on the display 16, the first catch phrase and the third catch phrase may be displayed on the display 16.

In step S210, it is determined whether an instruction to terminate the text generation process is given in accordance with a user operation. If the termination instruction is given, this routine is terminated. If the termination instruction is not given, the routine moves to step S202.

The receiving unit 62 may receive at least one notable word among the words included in the input text. In this case, the receiving unit 62 may receive multiple notable words together with the priorities thereof. FIG. 10 illustrates an example of a receiving screen for receiving notable words. As illustrated in FIG. 10, the receiving screen is provided with not only the input field 72 for inputting an input text but also multiple notable-word input fields 83 for respectively inputting notable words and multiple priority input fields 84 for respectively inputting the priorities of the notable words. In the example in FIG. 10, the user inputs “AI” as a notable word into one of the notable-word input fields 83 among the words included in the input text input into the input field 72 and also inputs “1” that is the highest priority for “AI” into one of the priority input fields 84. In addition, the user inputs “Python” as a different notable word in the other notable-word input field 83 and also inputs a priority of “2” into the other priority input field 84. In this case, after the user gives an instruction to generate a catch phrase by pressing the generation button 74, a catch phrase including the words “AI” and “Python” received by the receiving unit 62 among the generated catch phrases is output.

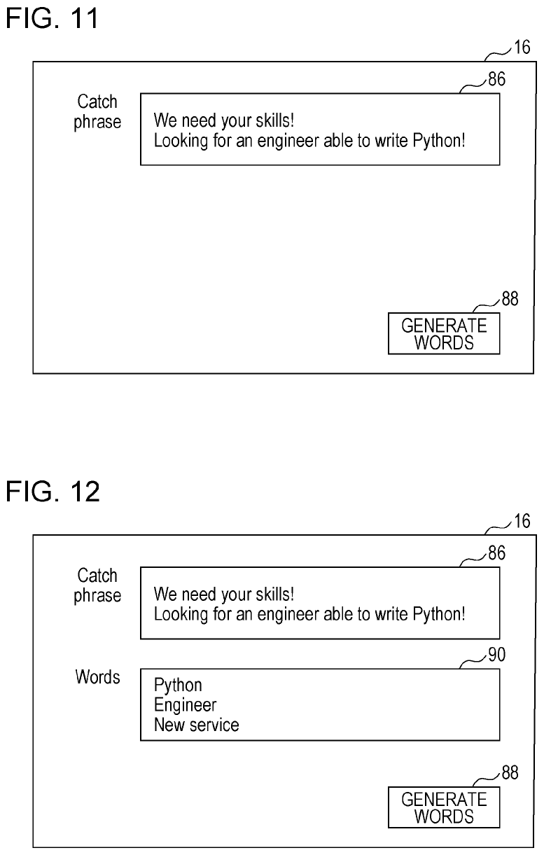

In addition, a catch phrase may be received as an input text, and words connected with the received input text may be output as a reconstructed text. For example, FIG. 11 illustrates a case where the user inputs the catch phrase “We need your skills! Looking for an engineer able to write Python!” into an input field 86. In this case, after the user presses a word generation button 88, generated words are displayed in a word field 90, as illustrated in FIG. 12. In the example in FIG. 12, the words “Python”, “Engineer”, and “New service” are displayed in the word field 90.

As described above, when a catch phrase is input, words connected with the input catch phrase are displayed. The user thus creates the catch phrase with reference to the words.

The exemplary embodiment has heretofore been described; however, the technical scope of the present disclosure is not limited to the scope described in the exemplary embodiment. Various modifications or improvements may be made to the exemplary embodiment described above without departing from the spirit of the disclosure. An exemplary embodiment to which the modification or the improvement is made may also be included in the technical scope of the present disclosure.

The exemplary embodiment does not limit the disclosure to the claims. Not all of the combinations of the features described in the exemplary embodiment are requisite for the solutions in the disclosure. The above-described exemplary embodiment includes the disclosure at various stages, and various disclosures are extracted by combining multiple disclosed components. Even if part of the components described in the exemplary embodiment is deleted, a configuration in which the part of the components is deleted may be extracted as a disclosure as long as effects thereof are exerted.

The case where the learning program and the text generation program are installed in advance in the memory 20 has heretofore been described in the exemplary embodiment; however, the present disclosure is not limited to the case. For example, the learning program and the text generation program may be provided in such a manner as to be stored in a storage medium such as a compact disc read only memory (CD-ROM) or may be provided via a network.

Further, the case where the learning process and the text generation process are implemented by running a program and by a software configuration using a computer has heretofore been described in the exemplary embodiment; however, the present disclosure is not limited to the case. For example, the learning process and the text generation process may be implemented by a hardware configuration or combination of the hardware configuration and the software configuration.

The configuration of the information processing apparatus 10 described in the exemplary embodiment (see FIG. 1) is an example. It goes without saying that a deletion of an unnecessary part and an addition of a new part may be made without departing from the spirit of the present disclosure.

The processing flow of the learning program and the text generation program described in the exemplary embodiment (see FIGS. 3 and 5) is also an example. It goes without saying that a deletion of an unnecessary step, an addition of a new step, and a change of the order of the process steps may be made without departing from the spirit of the present disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A non-transitory computer readable medium storing a program causing a computer to execute a process for learning, the process comprising:
generating, from an input text, an output text related to content of the input text and different from the input text by using a generation model that generates the output text from the input text;
reconstructing the input text from the output text by using a reconstruction model that reconstructs the input text from the output text; and
updating at least one of the generation model and the reconstruction model by causing the at least one of the generation model and the reconstruction model to perform learning by using a difference between the input text and a reconstructed text reconstructed in the reconstructing.

2. The non-transitory computer readable medium according to claim 1,
wherein in the updating, the generation model is updated by causing the generation model to perform learning by using a difference between a correct output text connected with the input text and the output text generated in the generating.

3. The non-transitory computer readable medium according to claim 1,
wherein in the generating, a word representation of the input text is generated, and the output text in the word representation is output,
wherein in the reconstructing, the reconstructed text is generated from the output text represented in the word representation, and
wherein in the updating, the at least one of the generation model and the reconstruction model is updated by causing the at least one of the generation model and the reconstruction model to perform the learning by using the difference between the reconstructed text represented in a word representation and the input text represented in the word representation.

4. The non-transitory computer readable medium according to claim 3,
wherein the reconstruction model acquires a word generated by using a Gumbel-Softmax function from the output text represented in the word representation and generates the reconstructed text represented in the word representation from the acquired word on a basis of distributed representation of the acquired word.

5. The non-transitory computer readable medium according to claim 1,
wherein in the updating, the generation model and the reconstruction model are updated by causing the generation model and the reconstruction model to perform the learning by using the difference between the input text and the reconstructed text.

6. The non-transitory computer readable medium according to claim 1,
wherein the generation model is an encoder-decoder model with an attention mechanism that generates the output text by performing weighting on words included in the input text.

7. The non-transitory computer readable medium according to claim 1,
wherein in the updating, a difference in probability at which the input text input in the generating and the reconstructed text reconstructed in the reconstructing are paired is calculated, and the generation model and the reconstruction model are updated, the difference being calculated by using a model that receives the input text input in the generating, the reconstructed text reconstructed in the reconstructing, and at least one input text different from the input text input in the generating and that calculates probability at which the input text input in the generating and the reconstructed text are paired and probability at which the different input text and the reconstructed text are paired, the generation model and the reconstruction model being updated by causing the generation model and the reconstruction model to perform learning by using the calculated difference.

8. The non-transitory computer readable medium according to claim 1,
wherein in the reconstructing, at least one of a process for reconstructing the input text from a word having a degree of importance equal to or higher than a predetermined degree of importance among words included in the output text and a process for reconstructing the input text from a word having a degree of importance equal to or higher than a predetermined degree of importance among words included in the reconstructed text is executed.

9. The non-transitory computer readable medium according to claim 8,
wherein in the reconstructing, degrees of importance of the words included in the output text are calculated by using term frequency-inverse document frequency.

10. The non-transitory computer readable medium according to claim 8,
wherein learning of the degrees of importance of the words is performed by using a learning model with the attention mechanism.

11. The non-transitory computer readable medium according to claim 1,
wherein the generation model generates the output text that is shorter than the input text.

12. A non-transitory computer readable medium storing a program causing a computer to execute a process for text generation, the process comprising:
generating, from an input text, an output text related to content of the input text and different from the input text by using a generation model that generates the output text from the input text and that is caused to perform the learning in the process in the non-transitory computer readable medium according to claim 1;
reconstructing the input text from the output text by using a reconstruction model that reconstructs the input text from the output text and that is caused to perform the learning in the process in the non-transitory computer readable medium according to claim 1; and
outputting at least one of the output text and a reconstructed text reconstructed in the reconstructing.

13. The non-transitory computer readable medium according to claim 12,
wherein in the generating, a plurality of the output texts are generated, and
wherein in the outputting, the plurality of the output texts and a plurality of the reconstructed texts that are respectively connected with the plurality of the output texts are output.

14. The non-transitory computer readable medium according to claim 12,
wherein in the reconstructing, only at least one of the reconstructed texts that has a difference lying between the input text and the reconstructed text and having a value lower than or equal to a threshold is output.

15. The non-transitory computer readable medium according to claim 14, the process further comprising:
threshold receiving in which the threshold is received.

16. The non-transitory computer readable medium according to claim 12,
wherein in the reconstructing, the input text is received, and a word connected with the received input text is output.

17. The non-transitory computer readable medium according to claim 12, the process further comprising:
modification receiving in which modification of the output text is received,
wherein in the reconstructing, the input text is reconstructed from the output text updated with the modification received in the modification receiving.

18. The non-transitory computer readable medium according to claim 12, the process further comprising:
notable-word receiving in which at least one notable word to be noticed among words included in the input text is received,
wherein in the generating, at least one of a plurality of the generated output texts that includes the notable word received in the notable-word receiving is output.

19. The non-transitory computer readable medium according to claim 18,
wherein in the notable-word receiving, a plurality of the notable words and priorities respectively assigned to the notable words are received, and
wherein in the generating, the output texts are generated from the input text having the notable words respectively weighted with the priorities.

20. The non-transitory computer readable medium according to claim 12,
wherein in the generating, at least one of a plurality of the generated output texts that has combination of words at least partially different from combination of words included in the reconstructed text is selected and output.
